(19) United States
(12) Patent Application Publication
(10) Pub. No.: US 2024/0356479 A1
(43) Pub. Date: Oct. 24, 2024

(54) METHOD FOR OPERATING AN ELECTRIC DRIVE SYSTEM, COMPUTER PROGRAM PRODUCT, DATA CARRIER AND ELECTRIC DRIVE SYSTEM

(71) Applicant: Robert Bosch GmbH, Stuttgart (DE)

(72) Inventors: Daniel Schweiker, Ludwigsburg (DE); Benjamin Lechner, Pforzheim (DE); Dominik Alexander Ruoff, St. Johann (DE); Kay Hindorf, Ludwigsburg (DE); Marco Salvatore Costa, Weil Im Schoenbuch (DE); Mark Damson, Stuttgart (DE)

(21) Appl. No.: 18/683,050

(22) PCT Filed: Jul. 25, 2022
(86) PCT No.: PCT/EP2022/070760

§ 371 Date: Feb. 12, 2024

(30) Foreign Application Priority Data
Sep. 3, 2021 (DE) 10 2021 209 683.2

(51) Int. Cl. H02P 29/032

(52) U.S. Cl. CPC H02P 29/032

(57) ABSTRACT

The invention relates to a method for operating an electric drive system (1) comprising power electronics (2), in particular an electric current converter, and comprising an electric machine (3) which can be controlled by the power electronics (2), wherein: the drive system (1) can be operated at least in one working mode and in a freewheeling mode as operating modes; the power electronics (2) have at least three electrical phases for controlling the electric machine (3); at least one current value of an electric current of one of the phases is monitored; the current value is compared to a predefined threshold value; and an active short circuit is activated as a safe operating state of the power electronics (2) if the current value exceeds the threshold value. According to the invention, the electric drive system (1) is monitored as to whether its current operating mode is the freewheeling mode, and the predefined threshold value is lowered to a freewheeling threshold value if the current operating mode has been recognized to be the freewheeling mode.

### BACKGROUND

The invention relates to a method for operating an electric drive system comprising power electronics, in particular an electric current converter, and comprising an electric machine which can be controlled by the power electronics, wherein: the drive system can be operated at least in one working mode and in a freewheeling mode as operating modes; the power electronics have at least three electrical phases for controlling the electric machine; at least one current value of an electric current of one of the phases is monitored; the current value is compared to a predefined threshold value; and an active short circuit is activated as a safe operating state of the power electronics if the current value exceeds the threshold value.

Further, the invention relates to a computer program product that performs the above method when the computer program product is executed on a computer device. Furthermore, the invention relates to a data carrier with such a computer program product as well as to an electric drive system with the computer device which is specially adapted to execute the computer program or the above-mentioned method, respectively.

Methods of the aforementioned type are known from the prior art. Usually, a device for monitoring the phase current is used to detect a defect of the electric drive system, especially an electric short circuit within the power electronics. When a predefined threshold value for the current is exceeded, a safe state is activated, in particular to prevent damage to other components of the electric drive system.

### SUMMARY

The method according to the invention is characterized in that the electric drive system is monitored as to whether its current operating mode is freewheeling mode, and that the predefined threshold value is lowered to a freewheeling threshold value when the presence of the freewheeling mode is detected. Monitoring the operating mode as to whether it is the freewheeling mode and lowering the threshold value to the freewheeling threshold value provides an advantageous means of detecting a defect in the electric drive system with virtually no delay. Timely detection is thus ensured in all operating modes because a corresponding comparison value, i.e., the threshold value or the freewheeling threshold value, is defined as a function of the detected operating mode. In particular, the defect is an electric short circuit within a half-bridge of a current converter. The freewheeling mode is understood to mean that the electric drive system is switched to current-free mode, i.e., in particular the electric machine does not perform any mechanical work. If the electric drive system is used in a motor vehicle, this is understood to mean, for example, so-called “sailing”, in which the electric machine is in a current-free freewheeling. Accordingly, the working mode is to be understood in particular as a generator operation or a motor operation of the electric machine in which work is performed. The freewheeling threshold value is set in its level in particular in such a way that it is above noise or disturbances of a sensor signal detecting the current value, so that a false triggering of the safe operating state is reliably avoided, but at the same time it is much lower than the threshold value. For example, the freewheeling threshold value is in the range of a few amperes, in particular 40 A, and the threshold value is in the range of a few kiloamperes, in particular 2000A.

According to a preferred further embodiment of the invention, the lowering to the freewheeling threshold value is performed with a predefined onset delay time after the presence of the freewheeling mode is detected. The onset delay advantageously ensures that lowering to the freewheeling threshold value does not occur until the freewheeling mode has been reliably detected and/or set. Preferably, the onset delay is such that at the time of drawdown, the electric current is below the freewheeling threshold value. In particular, the duration of the onset delay is selected to be so long that any electric currents still present have decayed, i.e., the electric drive system is actually de-energized. In particular, false triggering of the active short-circuit is avoided because the freewheeling threshold value as the underlying comparison value is too low before the applied electric currents decay, which advantageously increases the stability of the control or the execution of the method.

It is particularly preferred that monitoring of the operating mode and/or a request to set the operating mode is performed continuously, and that the freewheeling threshold value is increased to the predefined threshold value when the presence of or a request to set an operating mode other than the freewheeling mode is detected. The advantage of continuously monitoring and increasing to the predefined threshold value is that the freewheeling threshold value is only used or set when the freewheeling mode is present, so that false tripping of the active short circuit due to the value being too low is reliably avoided.

According to a preferred further embodiment of the invention, after the increase to the predefined threshold value, the setting of the other operating mode is performed with a predefined discharge delay time in time after the request to set the other operating mode is detected. The discharge delay advantageously ensures that the setting of an operating mode other than the freewheeling mode does not take place until an increase to the threshold value has been carried out. The setting of the other operating mode is therefore actively delayed. In particular, as already described above, false tripping of the active short-circuit is avoided because the freewheeling threshold value as the underlying comparison value for the currents now rising again is too low. Alternatively, monitoring of the current value is suspended at least for the duration of the discharge delay or the method is temporarily interrupted. In particular, the other operating mode is the working mode.

The computer program product according to the invention for execution on a computer device is characterized in that it executes the method according to the invention when used as intended. This results in the aforementioned advantages.

The data carrier according to the invention is characterized by the computer program product according to the invention stored thereon.

The electric drive system having the features of the disclosure has power electronics, in particular an electric current converter, and an electric machine which can be controlled by the power electronics, wherein the drive system can be operated at least in a working mode and in a freewheeling mode as operating modes, and wherein the power electronics have at least three electrical phases for controlling the electric machine. The electric drive system is characterized by a computer device specifically adapted to perform the method according to the invention or to execute the computer program product according to the invention. This also results in the advantages already mentioned above. In particular, the electric drive system is arranged in a motor vehicle. Preferably, the computer device is then a control unit located in the motor vehicle.

Particularly preferably, a comparator circuit is provided which is designed to monitor the current value and compare it with the predefined threshold value. By providing the comparator circuit, there is the advantage that the advantageous method is partially performed in hardware and the computational effort of the computer device is reduced. In particular, the computer device only has to decide whether the active short circuit has to be activated depending on the output signals provided by the comparator circuit, and control the power electronics accordingly. Preferably, the activation of the short circuit is also carried out by hardware specially designed for this purpose, so that the load on the computer device is further reduced.

### BRIEF DESCRIPTION OF THE DRAWINGS

Further preferred features and combinations of features result from the above-described and from the claims. The invention is explained in more detail below with reference to the drawings. The figures show:

FIG. 1 a highly simplified schematic representation of an electric drive system,

FIG. 2 an advantageous method for operating the electric drive system,

FIG. 3 a diagram of a time course of an electric current in the electric drive system in case of a defect, and

FIGS. 4A through 4C further diagrams of time courses of electric currents and state variables when carrying out the advantageous method.

### DETAILED DESCRIPTION

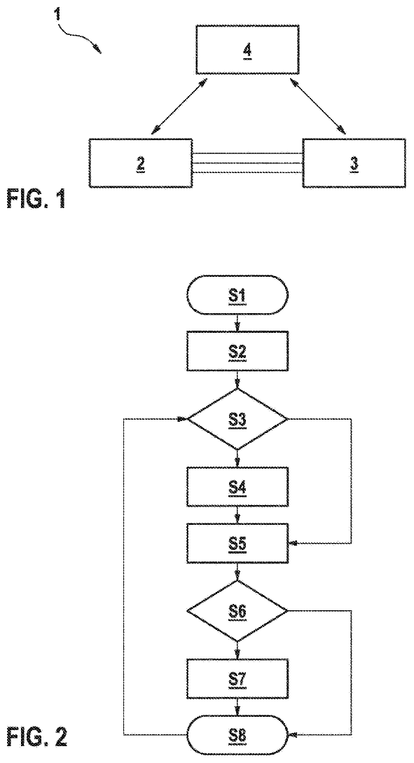

FIG. 1 shows a highly simplified schematic representation of an electric drive system 1, in particular for a motor vehicle not shown. The electric drive system 1 features power electronics 2. The power electronics 2 is designed as an electric current converter to control an electric machine 3.

For this purpose, the power electronics 2 has at least 3 electrical phases for controlling the electric machine 3, as shown by three connecting lines between the power electronics 2 and the electric machine 3.

The drive system 1 can be operated in at least a working mode and a freewheeling mode as operating modes.

A computer device 4, in particular designed as a control unit of the motor vehicle, is connected to the power electronics 2 and/or the electric machine 3 by means of communication, as indicated by corresponding double arrows. In particular, the computer device 4 is designed to determine an operating state of the power electronics 2, for example by means of suitable sensor technology, which is also not shown, and to monitor an operating state of the drive system 1.

In the following, an advantageous method for operating the electric drive system 1 is described with reference to FIG. 2. FIG. 2 shows the method in the form of a flow chart. In particular, the method ensures that a defect in the electric drive system 1 is detected reliably and quickly, regardless of the operating mode.

In a step S1, the method starts, for example automatically, as soon as the computer device 4 is supplied with electric power. Preferably, the computer device 4 then automatically performs all the steps of the method described below. Alternatively, at least some of the steps are implemented in hardware, such as a comparator circuit, to reduce the computational load on the computer device 4.

In a step S2, a pre-stored threshold value for a current value of an electric current of one of the phases of the electric machine 3 is retrieved.

In a step S3, the operating mode of the electric drive system 1 is monitored. If it is now detected that a mode other than the freewheeling mode is present as the operating mode, the method is continued with a step S5.

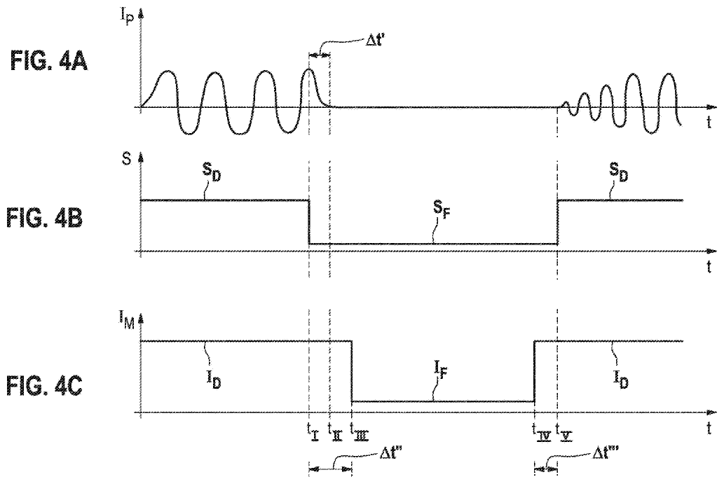

However, if the freewheeling mode is recognized as the operating mode, the threshold value retrieved in the step S2 is lowered in a step S4 to a freewheeling threshold value that is also predefined or stored in advance. So the freewheeling threshold value is lower, preferably much lower than the threshold value. Preferably, the lowering to the freewheeling threshold value takes place with a predefined onset delay time, as will be explained with reference to FIG. 4.

In the step S5, at least one current value of an electric current of one of the phases of the electric machine 3 is then monitored. Preferably, a current value is recorded for each of the three phases.

In a step S6, the at least one current value is then compared, depending on the result from step S3, with a respectively valid comparison value, i.e., the threshold value or the freewheeling threshold value. If it is now detected that the current value is smaller than the comparison value, the method is continued with a step S8.

However, if it is detected that the current value is greater than the comparison value, an active short circuit is activated in a step S7 as a safe operating state of the power electronics 2.

In a step S8, a first run of the method ends. Preferably, however, the monitoring of the operating mode is performed continuously, so that the method now jumps back to step S3 and is run through again. In particular, the method is terminated after a predefined number of runs, otherwise it alternatively ends only when the computer device 4 is no longer supplied with power.

Preferably, step S3 also monitors whether there is a request to set the operating mode. In particular, after increasing to the predefined threshold value in the step S4, the setting of the other operation mode is then also performed with a predefined discharge delay time after the request to set the other operation mode is detected, as will also be explained with reference to FIG. 4.

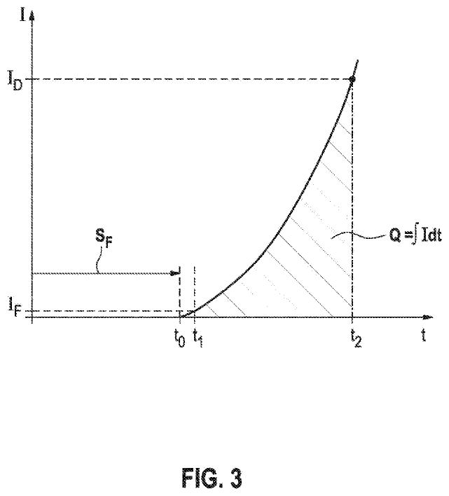

FIG. 3 shows a diagram of a curve of an electric current I in the electric drive system 1 over time t in the event of a fault. A threshold value I_{D} is predefined for a current value of the electric current I. To detect a defect in the electric drive system 1, the current value is first compared with the threshold value I_{D}, as described above.

As indicated by an arrow, the electric drive system 1 is, over the entire course of time, in a freewheeling mode S_{F} as an operating mode in which it is de-energized. Up to a time t₀the current value of the electric current I is actually zero or at least approximately zero. At the time t₀, a defect, in particular a short circuit, occurs in the electric drive system 1, which causes the current value to increase.

Based on the level of the threshold value I_{D}, the defect is detected at a time t₂ when the current value exceeds the threshold value I_{D}. By time t₂, a significant electric charge Q, namely the current integral between time t₀ and t₂, has flowed. Analogously, this also applies to the value of the limiting load integral (so-called I²t value), i.e., the area below the square of the electric current, which is usually used as a criterion for the load capacity of electrical components.

If, however, a much lower freewheeling threshold value I_{F} is set instead of the threshold value I_{D} when carrying out the method according to the invention, the defect is already detected at a time t₁ at which the current value exceeds the freewheeling threshold value I_{F}.

Thus, a considerably lower electric charge Q, namely the current integral, has flowed between the times t₀ and t₁ (analogously, the limiting load integral also has a considerably lower value), so that the risk of permanent damage to the electric drive system 1 or components connected to it is advantageously considerably reduced in comparison.

FIGS. 4A through 4C show further diagrams of time courses of electric currents and state variables when carrying out the advantageous method.

For example, FIG. 4A shows an exemplary characteristic of a current value of an electric current I_{P} of one of the electric phases for controlling the electric machine 3.

FIG. 4B shows a state diagram of an operating mode (state) of the drive system 1, which changes over time from a working mode S_{D} to a freewheeling mode S_{F} and back to the working mode S_{D}.

Finally, FIG. 4C shows a progression of a predefined comparison value I_{M} for the electric current that changes over time from a threshold value I_{D} to a freewheeling threshold value I_{F} and back to the threshold value I_{D} again.

In the following, the changes that occur over time and their temporal dependence on each other during the implementation of the advantageous method will be described. For this purpose, a change from the working mode S_{D} to the freewheeling mode S_{F} takes place at a time t_{I}. This is detected preferably without delay when monitoring the operating mode during the execution of the method.

By a time t_{II}, the current then drops to zero or near zero. This decrease occurs with a delay Δt′, i.e., the time difference between the times t_{I} and t_{II}. This completes the change to freewheeling mode S_{F}.

At a time t_{III} after the time t_{II}, the predefined comparison value I_{M} is then reduced from the threshold value I_{D} to the freewheeling threshold value I_{F}. Accordingly, this is done with an onset delay Δt″, i.e., the time difference between the times t_{I} and t_{III}. In this way, it is advantageously ensured that the suitable comparison value I_{M} is not set until the current value has dropped sufficiently, and that false triggering of the safe operating state is reliably avoided.

If a request to set or return to the drive mode S_{D} is now detected over time after the time t_{III}, the threshold value I_{D} is initially set again as the comparison value I_{M} at a time t_{IV} after detection.

At a time t_{V} after the time t_{IV}, the drive mode S_{D} is then also set. Accordingly, this is done with a discharge delay Δt′″, i.e., the time difference between the time t_{IV} and t_{V}. At the same time, the current value of the electric current I increases again. In this way, it is advantageously ensured that the suitable comparison value I_{M} established before the current value increases again and that false triggering of the safe operating state is reliably avoided.

1. A method for operating an electric drive system (1), having power electronics (2), and having an electric machine (3) configured to be controlled by the power electronics (2),
wherein the drive system (1) is configured to be operated at least in a working mode (S_{D}) and in a freewheeling mode (S_{F}) as operating modes, wherein the power electronics (2) have at least three electrical phases for controlling the electric machine (3),
wherein a current value of an electric current of one of the phases is monitored,
wherein the current value is compared to a predefined threshold value (I_{D}), and
wherein an active short circuit is activated as a safe operating state of the power electronics (2) when the current value exceeds the threshold value (I_{D}), wherein
the electric drive system (1) is monitored as to whether its current operating mode is the freewheeling mode (S_{F}), and
the predefined threshold value (I_{D}) is lowered to a freewheeling threshold value (I_{F}) when the presence of the freewheeling mode (S_{F}) is detected.

2. The method according to claim 1, wherein the lowering to the freewheeling threshold value (I_{F}) is performed with a predefined onset delay time (Δt″) after the presence of the freewheeling mode (S_{F}) is detected.

3. The method according to claim 1, wherein the monitoring of the operating mode and/or of a request to set the operating mode is performed continuously, and in that the freewheeling threshold value (I_{F}) is increased to the predefined threshold value (I_{D}) when the presence of or a request to set an operating mode other than the freewheeling mode (S_{F}) is detected.

4. The method according to claim 3, wherein after increasing to the predefined threshold value (I_{D}), the setting of the other operating mode is performed with a predefined discharge delay time (Δt′″) after the request to set the other operating mode is detected.

5. A non-transitory, computer-readable medium containing instructions that when executed by a computer cause the computer program to operate an electric drive system (1), having power electronics (2) and an electric machine. wherein the drive system (1) is configured to be operated in a working mode (S_{D}) and in a freewheeling mode (S_{F}) as operating modes, wherein the power electronics (2) have at least three electrical phases for controlling the electric machine (3), by
monitoring a current value of an electric current of one of the phases,
comparing the current value to a predefined threshold value (I_{D}).
activating an active short circuit as a safe operating state of the power electronics (2) when the current value exceeds the threshold value (I_{D}),
monitoring the electric drive system (1) as to whether its current operating mode is the freewheeling mode (S_{F}), and
lowering the predefined threshold value (I_{D}) to a freewheeling threshold value (I_{F}) when the presence of the freewheeling mode (S_{F}) is detected.

6. (canceled)

7. An electric drive system (1) comprising
power electronics (2),
an electric machine (3) configured to be controlled by the power electronics (2), wherein the drive system is configured to operate in a working mode (S_{D}) and in a freewheeling mode (S_{F}) as operating modes, and the power electronics (2) having at least three electrical phases for controlling the electric machine (3), and
a computer configured to
monitor a current value of an electric current of one of the phases,
compare the current value to a predefined threshold value (I_{D}),
activate an active short circuit as a safe operating state of the power electronics (2) when the current value exceeds the threshold value (I_{D}).
monitor the electric drive system (1) as to whether its current operating mode is the freewheeling mode (S_{F}), and
lower the predefined threshold value (I_{D}) to a freewheeling threshold value (I_{F}) when the presence of the freewheeling mode (S_{F}) is detected.

8. The electric drive system according to claim 7, wherein a comparator circuit adapted to monitor the current value and compare it with the predefined threshold value (I_{D}) and/or the freewheeling threshold value (I_{F}).
